(19) United States
(12) Patent Application Publication
(10) Pub. No.: US 2026/0141536 A1
(43) Pub. Date: May 21, 2026

(54) PIXEL-WISE TRACKING OF BACKGROUND OBJECTS IN DYNAMIC VIDEO USING INTRA-FRAME AND INTER-FRAME SMOOTHING

(71) Applicant: Mitsubishi Electric US, Cypress, CA (US)

(72) Inventors: Zafer Sahinoglu, Costa Mesa, CA (US); Buse Yaren Kazangirler, Cypress, CA (US); Dilara Ozdemir, Cypress, CA (US); Cahit Berkay Kazangirler, Cypress, CA (US); Abdulazeez Mohammed A-zeez Ameen Agha, Cypress, CA (US)

(73) Assignee: Mitsubishi Electric US, Cypress, CA (US)

(21) Appl. No.: 19/094,851

(22) Filed: Mar. 29, 2025

Related U.S. Application Data
(60) Provisional application No. 63/721,759, filed on Nov. 18, 2024.

(51) Int. Cl. G06T 7/246; G06T 5/70

(52) U.S. Cl. CPC G06T 7/248; G06T 5/70; G06T 2207/10016; G06T 2207/20084

(57) ABSTRACT

Technology is disclosed herein for object tracking in dynamic video in various implementations. In an implementation, an image processing system comprising a processor coupled with stored instructions direct the image processing system to collect a sequence of frames of a video of a scene; process the sequence of frames with a neural network trained to segment and track a background object in the scene; modify the segmented object in at least some of the frames by intra-frame smoothing, wherein intra-frame smoothing comprises enforcing a geometrical constraint on a shape of the segmented object; estimate an internal motion of the segmented object in the sequence of frames caused by the intra-frame smoothing; perform an inter-frame smoothing of the internal motion of the segmented object in the sequence of frames to smoothly track the segmented object in the video; and perform a downstream task on the tracked segmented object.

### CROSS REFERENCE TO RELATED APPLICATION

This application is related to and claims the benefit of priority to U.S. Provisional Patent Application entitled “PIXEL-WISE TRACKING OF BACKGROUND OBJECTS IN DYNAMIC VIDEO USING INTRA-FRAME AND INTER-FRAME SMOOTHING,” Application No. 63/721,759, filed 18 Nov. 2024, the contents of which is incorporated by reference in its entirety for all purposes.

### TECHNICAL FIELD

Aspects of the disclosure are related to the field of object detection and tracking in video frames.

### BACKGROUND

Object detection and image segmentation are two essential tasks in computer vision, widely used to understand and interpret visual data. Object detection refers to identifying instances of objects from predefined categories within an image. It not only identifies what objects are present but also provides their locations in the form of bounding boxes. Popular object detection models include various neural network architectures, such as YOLO (You Only Look Once) known for its real-time detection capability to detect multiple objects in a single forward pass of the network, Faster R-CNN (Region-Based Convolutional Neural Network) that uses a region proposal network to propose possible object regions and then classifies and refines them, and SSD (Single Shot MultiBox Detector) that detects objects in a single shot without the need for a region proposal network.

In contrast, image segmentation is the process of partitioning an image into multiple segments (or regions) to simplify its analysis. In object segmentation, the task is to delineate each object instance in an image more precisely by marking each pixel that belongs to the object. Instead of bounding boxes, segmentation uses pixel-wise labeling to assign a label to each pixel, determining which pixels belong to which objects. As a result, segmentation models typically use different model architectures, such as Mask R-CNN, U-Net, and DeepLab.

Pixel correspondence refers to the process of identifying and matching pixels between different images or frames that correspond to the same physical point in the scene. It plays a crucial role in many computer vision tasks, such as stereo vision, optical flow, structure-from-motion, and image stitching. The goal is to establish which pixels in one image correspond to the same physical point in another image, enabling various downstream tasks such as 3D reconstruction or motion tracking.

Unfortunately, pixel correspondence is a notoriously challenging task often requiring special treatment using multi-model sensors, specific emitters marking landmark locations, or chroma keying involving filming videos on a green screen that serves as a uniform background that can be easily distinguished from the subject in front of it. However, for many applications such as autonomous driving involving lane and obstacle detection, medical imaging tracking tumors or other anomalies, and manipulation of live stream video, such a special treatment is unavailable.

### SUMMARY

Technology is disclosed herein for object tracking in dynamic video in various implementations. In an implementation, an image processing system comprising a processor coupled with stored instructions that, when executed by the processor, direct the image processing system to collect a sequence of frames of a video of a scene; process the sequence of frames with a neural network trained to segment and track a background object in the scene; modify the segmented object in at least some of the frames by intra-frame smoothing, wherein intra-frame smoothing comprises enforcing a geometrical constraint on a shape of the segmented object; estimate an internal motion of the segmented object in the sequence of frames caused by the intra-frame smoothing; perform an inter-frame smoothing of the internal motion of the segmented object in the sequence of frames to smoothly track the segmented object in the video; and perform a downstream task on the tracked segmented object.

In another implementation, a method of operating a computing device comprises collecting a sequence of frames of a video of a scene; processing the sequence of frames with a neural network trained to segment and track a background object in the scene; modifying the segmented object in at least some of the frames by intra-frame smoothing, wherein intra-frame smoothing comprises enforcing a geometrical constraint on a shape of the segmented object; estimating an internal motion of the segmented object in the sequence of frames caused by the intra-frame smoothing; performing an inter-frame smoothing of the internal motion of the segmented object in the sequence of frames to smoothly track the segmented object in the video; and performing a downstream task on the tracked segmented object.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIGS. 1A and 1B illustrate operational sequences for object tracking in video in an implementation.

FIG. 2 illustrates a process for object tracking in video in an implementation.

FIGS. 3A, 3B, and 3C illustrate a process for object tracking with intra-frame and inter-frame smoothing in an implementation

FIG. 4 illustrates a detailed operational sequence for object tracking in video in an implementation.

FIG. 5 illustrates a process for quantifying external motion in an implementation.

FIG. 6 illustrates an operational scenario for inter-frame smoothing in an implementation.

FIGS. 7A and 7B illustrate a linear regression technique and a slope-based non-uniform warping algorithm for intra-frame smoothing for object tracking in video in an implementation.

FIG. 8 illustrates a process for object tracking and stabilization in video frames in an implementation.

FIG. 9 illustrates a custom reversed function technique for object tracking in video frames in an implementation.

FIGS. 10A and 10B illustrate an operational sequence and architecture for object tracking in dynamic video in an implementation.

FIG. 11 illustrates a neural network architecture for a process of object tracking in an implementation.

FIG. 12 illustrates a computing system suitable for implementing the various operational environments, architectures, processes, scenarios, and sequences discussed below with respect to the other Figures.

### DETAILED DESCRIPTION

It is an object of some embodiments to provide a system and a method for real-time tracking of background objects within a sequence of frames of a video of a scene. The tracked and segmented background objects are the input to a subsequent downstream application performing a task. On one hand, tracking stationary background objects, such as buildings, traffic signs, road segments, banners, or even skeletons surrounding organs in medical imaging should be easier than the foreground objects which are able to move. However, in many videos, the scene itself has its own dynamics caused by the motion of a camera, field of view (FOV), and other operations of the camera. Indeed, when filming, changes in the field of view (FOV), zooming in or out, and changing depth of field can significantly impact the motion and perception of a scene. These camera operations alter how the viewer experiences depth, motion, and scale within a shot, leading to various visual effects. These camera operations may be advantageous for the viewer experience but may complicate the estimation of the pixel correspondence even for the stationary background objects.

One example of how dynamic camera operation affects the viewer experience involves FOV. The FOV refers to the extent of the observable scene captured by the camera; changing the FOV alters how much of the scene is visible. A wider FOV captures a broader area of the scene and gives the viewer a sense of openness or vastness. It is typically achieved with wide-angle lenses or by zooming out. In contrast, a narrower FOV focuses on a smaller portion of the scene, making it more concentrated. This can be achieved using a telephoto lens or zooming in. Often, camera operations are combined for more sophisticated effects. For example, a dolly zoom, also known as the Vertigo effect, occurs when the camera physically moves closer to or away from the subject (dolly in/out) while simultaneously zooming in or out to keep the subject the same size in the frame. The dolly zoom may cause the distortion of perspective when the background appears to stretch or compress while the subject remains relatively the same size, creating an unsettling, dramatic effect. This technique plays with the perception of depth and motion illusion.

Hence, the background objects in a scene of a dynamic video (e.g., a video with dynamic camera operation) may have their own dynamics or motion derived from the dynamics of the video caused by these and/or other operations of the camera. As a result, the shape of a background object may appear distorted, and the distortion may vary from frame to frame. Further, the location of the background objects may move between the different frames. These features complicate object tracking and segmentation using models trained with machine learning that are fast enough to process real-time video, but too statistical in nature to account for all possible distortions and displacements.

Some embodiments of the technology disclosed herein are based on recognizing that the distortion within each frame, referred to herein as intra-frame distortion, of a background object caused by the dynamics of the video can be corrected by enforcing geometrical constraints on the tracked object. For example, if the shape of a background object includes a straight segment, such as a rectangular banner, the linear regression of the tracked pixels can be used to enforce this geometrical constraint. Alternatively, if the contour of a shape is non-linear, e.g., curved, a non-linear regression based on splines can be used. This approach is referred to herein as intra-frame smoothing and is advantageous because it can address both the distortions caused by the camera operation and inaccuracies of the machine learning model used for the segmentation.

However, this intra-frame smoothing introduces a different problem of jittering. Because the distortion and inaccuracies of the model typically will vary from frame to frame, the intra-frame smoothing via enforcing geometrical constraints breaks the principles of pixel correspondence which involves identifying and matching corresponding pixels in different images or frames that represent the same point in a scene. Indeed, the intra-frame smoothing can force a correspondence of pixels that do not correspond to each other without the smoothing. Or vice versa, one or both of the corresponding pixels may be forced out of the segmented object by the regression. As a result, intra-frame smoothing using the geometrical constraints can cause an internal motion of the background object that is independent of the external motion caused by the dynamics of the video. This independent internal motion combined with the external motion caused by camera operations in recording the video has a compound effect which can degrade the quality of the object tracking.

Accordingly, some embodiments disclose pixel-wise tracking of the background objects in dynamic video using intra-frame smoothing of the segmented objects within each frame and inter-frame smoothing of the tracked objects between the frames. While intra-frame smoothing addresses the problems of distortion of the object by enforcing geometrical constraints, inter-frame smoothing aims to separate the internal motion of the segmented object (caused by intra-frame smoothing) from the external motion of the segmented object caused by the dynamics of the video and smooth out only the effect of the internal motion.

Various implementations are disclosed herein for improved object tracking in dynamic video (e.g., video with camera-induced motion), including pixel-wise tracking of background objects in video streams using intra-frame and inter-frame smoothing. The improved tracking may be used for video editing or rendering tasks such as replacing or superimposing text or imagery on background objects in the frames of a video stream. The technology disclosed herein is particularly beneficial in scenarios where the image captured in the video stream is subject to dynamic camera operation and changing field of view (FOV).

In an exemplary scenario, in a televised broadcast of a sporting event, background banners or signs which are physically present at the event may be replaced in the televised broadcast with other signage, allowing targeted, personalized advertisements, or other virtual signage to be displayed in place of the physical signage. To replace a background object with an overlay, the video stream may be processed using convolution neural networks (CNN) for object detection and image segmentation which identify and track the background object. However, camera operations (e.g., camera motion, zooming in/out) can introduce relative motion effects of the background objects from one frame to the next. For example, a background object may appear in one location in one frame and in a different location in the next frame due to the movement of the camera. Relative motion effects can also cause the shape of the background object to be distorted, with the distortion varying from frame to frame. Thus, the relative motion effects can degrade the quality of the object tracking and thus degrade the quality of the resulting video in replacing the background object with an overlay.

Technology is disclosed herein which includes intra-frame smoothing and inter-frame smoothing. With intra-frame smoothing, intra-frame distortion of a tracked background object after segmentation is corrected using regression techniques. Because intra-frame smoothing can introduce an internal motion in the video stream (by interfering with pixel correspondence) that is independent of any external motion, inter-frame smoothing is applied to smooth out the effects of the internal motion, thereby improving the quality of the object tracking and video editing. The combined use of intra-frame smoothing (to correct distortions) and inter-frame smoothing (to mitigate internal motion artifacts) enables more accurate tracking and segmentation of background objects in dynamic videos

In various implementations, inter-frame smoothing can include motion filtering, optical flow analysis, geometric alignment, temporal smoothing using regression, or other methods. Motion filtering can include the use of a Kalman filter to predict and smooth the motion of objects over time. Motion filtering can also include an exponential moving average (EMA) function which smooths abrupt changes in object positions across frames. Optical flow analysis may be used to calculate the optical flow between consecutive frames to track pixel-level motion. The actual optical flow is compared with the motion predicted by inter-frame smoothing and the trajectory of the object adjusted by aligning it with the expected motion based on optical flow. In geometric alignment, feature matching (e.g., with keypoints detected using SIFT or ORB) is used across frames to ensure the object's geometry remains consistent. Object positions are refined by enforcing temporal consistency in the shape and location of objects. In temporal smoothing using regression, temporal regression is performed on the object's motion trajectory across multiple frames. Polynomial or spline regression can be used to fit a smooth curve to the sequence of object positions. In weighted averaging of pixel correspondence, corresponding pixels are tracked over time and a weighted average of their positions is calculated. Higher weights are assigned to correspondences with less distortion or higher confidence scores from the model.

In an implementation of the technology disclosed herein, the process described herein addresses challenges in tracking and segmenting background objects in dynamic videos with camera-induced motion and object distortions. Background objects in dynamic videos may appear distorted due to camera operations, with distortions and displacements varying frame-to-frame. This complicates real-time object tracking and segmentation using machine learning models, which are statistical and may not account for all distortions. For example, the use of an incomplete CNN with constrained active layers for localized feature embeddings (for traceability or explainability) may introduce inaccuracies in the segmentation. In some cases, the CNN may be of low fidelity, that is, lacking the capability to capture a very accurate representation of the segmented object due to a shallow architecture, training on low-resolution images, low-precision computation, etc. Distortions within individual frames arising from imperfect segmentation are corrected by a first smoothing (or distortion smoothing) procedure of a two-stage smoothing process which includes applying geometrical constraints to tracked objects. Linear regression is used for objects with straight edges (e.g., banners), and non-linear regression is used for curved contours (e.g., splines). This method reduces inaccuracies in object segmentation caused by distortions and model limitations.

Enforcing geometrical constraints disrupts pixel correspondence across frames, causing internal motion artifacts. This internal motion, combined with external motion from camera dynamics, degrades the quality of object tracking. To address this, a second smoothing (or motion smoothing) procedure of the two-stage process separates internal motion (from corrections within the frames) from external motion (from camera dynamics). The second smoothing smooths out internal motion effects while preserving the overall tracking quality. The combined use of first smoothing (to correct distortions) and second smoothing (to mitigate internal motion artifacts) enables more accurate tracking and segmentation of background objects in dynamic videos.

Technical effects of the technology disclosed herein include improved video rendering for overlaying graphics (e.g., text or images) in video streams with dynamic camera operations. Because machine learning methods for object detection and image segmentation are susceptible to distortion from dynamic camera operations, the technology disclosed herein improves rendering overlays by a performing a two-stage smoothing operation, first, using geometric constraints to smooth the boundaries of a segmented object within each frame, and second, separating the internal motion of the segmented object from external motion arising from camera dynamics to smooth out only the effects of the internal motion. As a result, with more accurate object segmentation, graphical overlays can be rendered more realistically within the context of the scene while reducing or eliminating the artifacts associated with breaking pixel correspondence which can occur with the use of the geometric constraints.

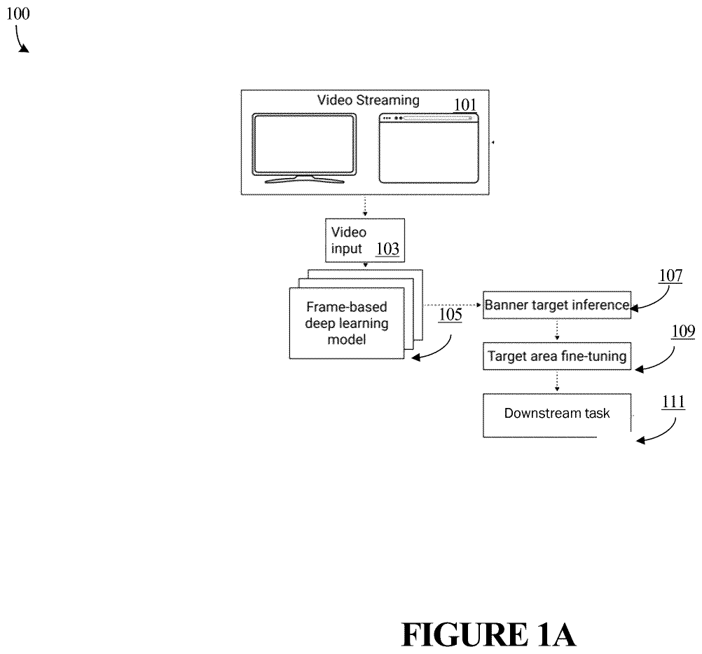

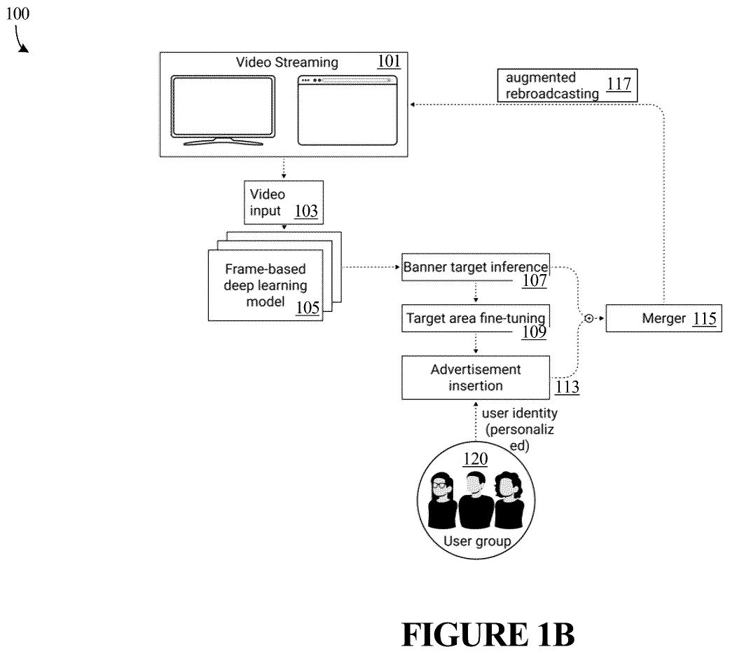

Turning now to the Figures, FIGS. 1A and 1B illustrate workflows 100 and 110, respectively, for object tracking in dynamic video in an implementation. In workflow 100 at step 101, a streamed (e.g., livestreamed) video is received by a display such as a television or display screen (e.g., in a user interface) of a computing device. In some scenarios, the video is a broadcast of a sporting event in a venue such as an arena or stadium, and includes camera operations such as changing FOV, zooming in/out, and other operations. A graphical overlay is to replace a designated area (e.g., the image of a physical banner at the venue) within the scene captured in the video so that the overlay is visually cohesive with the rest of the scene (e.g., replacing the banner at the venue with an advertising graphic).

To identify a target area for the overlay, the video is received as input (step 103) to a frame-based deep learning model which is trained for object segmentation (step 105). The input may include sequences of frames of the video configured as input or feature vectors for processing by the deep learning model. The feature or input vector can include pixel data including RGB (red, green, blue) values; the structure of the input vector may comprise data values organized in an array such that the values are accessible by an index corresponding to each position in the array. The deep learning model, such as YOLO, SSD, or faster R-CNN model, may be trained for classifying objects detected in the camera view of the video, such as stationary banners displayed at the sporting event and other objects relating to the streamed content, such as players, referees, goalposts, balls, flags, other objects, and so on.

In step 107 of workflow 100, the output of the model includes a target area comprising the shape and boundary (e.g., linear edges) of an object classified as a banner. In step 109, the target area of the banner object is fine-tuned by applying a two-stage smoothing technique to the target area according to the technology disclosed herein (i.e., intra-frame smoothing and inter-frame smoothing). From step 109, the target area of the banner object is now ready for a downstream task, such as blurring or pixelating private or personally identifiable information (e.g., faces, license plate numbers, sensitive content), adding augmented reality effects, adding adaptive camera effects (e.g., selective focus or depth-of-field effects), motion prediction, overlaying virtual content or graphics, and the like.

Workflow 110 of FIG. 1B proceeds in a manner similar to that of workflow 100. In workflow 110, however, after step 109, a downstream task is performed in an advertisement is inserted in the masked area of the target object of the video frames, replacing the existing content in the masked area (step 113). The advertisement may be selected based on the viewing audience or user who is receiving the video (e.g., targeted ad placement), or the advertisement may be selected based on other factors (step 120).

Continuing with the workflow 110, the target area of the banner object is merged with the selected advertisement so that the selected advertisement replaces the banner (step 115). For example, in a given frame in the sequence of video, a mask may be created based on the fine-tuned target area of the banner object, and a graphical object of the selected advertisement is inserted in place of the mask. The merged video (i.e., the video merged with the replacement content) is then played as an augmented rebroadcast of the video input on the display (step 117).

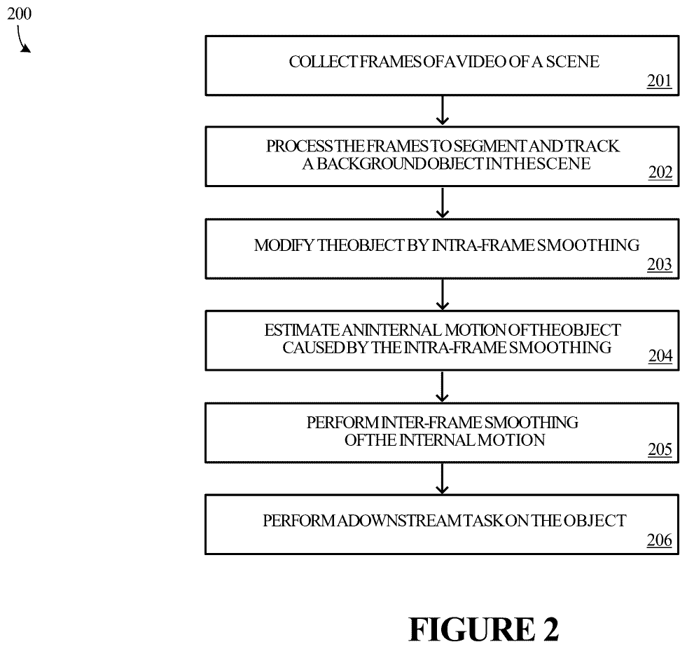

FIG. 2 illustrates a method of object tracking in dynamic video in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, the computing device collects a sequence of frames of a video of a scene (step 201). In an implementation, a video is captured and broadcasted in real-time (or livestreamed) which includes scenes with varying FOV (e.g., pan, sweep), focal length (e.g., zoom in/out), and other camera operations. The video may include metadata relating to the camera operations, such as position and orientation with respect to elements of the scene or location being recorded, focal length, resolution, aspect ratio, and so on.

The computing device processes the sequence of frames with a neural network trained to segment and track a background object in the scene (step 202). In an implementation, a neural network model for object segmentation, such as a YOLO, SSD, or R-CNN model receives as input a sequence of frames from the video including pixel data. The pixel data may include RGB values. The neural network model is trained to segment and classify or label the background object in each frame. The model may also segment and classify other objects, particularly objects which may appear in the foreground or in front of the targeted object (e.g., players, referees, flags).

The computing device modifies the segmented object in at least some of the frames by intra-frame smoothing comprising enforcing a geometrical constraint on a shape of the segmented object (step 203). In an implementation, a segmented object corresponding to a target object classification (e.g., a banner object) may include linear elements (e.g., linear edge or border) to which a linear geometric constraint can be applied. For example, if the target object classification is a rectangular banner, a linear regression constraint can be applied to the top and bottom edges. Where the target object includes non-linear elements, a non-linear geometric constraint (e.g., a spline) may be applied.

The computing device estimates an internal motion of the segmented object in the sequence of frames caused by the intra-frame smoothing (step 204). In an implementation, an internal motion may be created based on intra-frame smoothing as it is applied individually to each frame in the sequence. The internal motion arises from a disruption of the pixel correspondence of the segmented object from one frame to the next. As a result, after intra-frame smoothing has been applied, as the sequence of frames is played, the segmented object would appear to move in jittery motion.

The computing device performs inter-frame smoothing of the internal motion of the segmented object in the sequence of frames to smoothly track the segmented object in the video (step 205). In an implementation, to perform inter-frame smoothing of the internal motion (e.g., jitter), the internal motion is distinguished from external motion which arises from dynamic camera operation in capturing the video. For example, in the sequence of frames, the camera may pan an area encompassing the segmented object. As a result, the location of the segmented object will vary with each frame causing the segmented object to “move” across the scene from one frame to the next. The effect of any detected or identified external motion arising from camera operation is separated from the internal motion. For example, the components of the external motion (e.g., in Cartesian coordinate system) may be subtracted from the internal motion. Next, with the external motion effects removed, the internal motion is mitigated by applying a stabilization algorithm to the frames or to the segmented object.

To smooth the internal motion of the segmented object in a sequence of frames, an Exponential Moving Average (EMA) function may be applied. The EMA function computes a new position of the background object based on the position of the object in the previous frame to mitigate the internal motion or jitter. In some implementations, the inter-frame smoothing process includes a Kalman filter for tracking the segmented object using a motion model including the external motion and a measurement model including measurements of pixels of the segmented object modified with the intra-frame smoothing. For example, a Kalman filter may be used to track a segmented object by predicting its motion using a motion model that accounts for external influences, such as velocity or acceleration. The measurement model integrates pixel-level data from the segmented object, refined by intra-frame smoothing, which reduces noise and ensures consistency between consecutive video frames. Thus, the Kalman filter can be used to combine the predicted motion with smoothed measurements, resulting in robust and accurate tracking of the segmented object's position and trajectory over time.

The computing device performs a downstream task on the tracked segmented object (step 206). In an implementation, after the target object has been fine-tuned by intra-frame and inter-frame smoothing, a mask is created based on the fine-tuned target object to delineate the area to be replaced by the graphical overlay. The graphical overlay is then merged into each of the frames according to the masks generated based on the target object. In some cases, portions of the masks may be occluded by objects that were identified (by the neural network model) as being in front of the segmented object so that when the overlay is merged to the frames, the objects in front of the target object will not be covered or replaced by the overlay. In various implementations, the mask is created after the initial object segmentation, and the intra-frame and inter-frame smoothing is applied to the mask.

In an implementation, with a target object segmented, in each frame, a mask is created based on the target object segmentation. The mask is used to replace the segmented object with a graphic overlay, such as a banner advertisement. The steps of process 200, such as steps 203-206, are performed on the overlay.

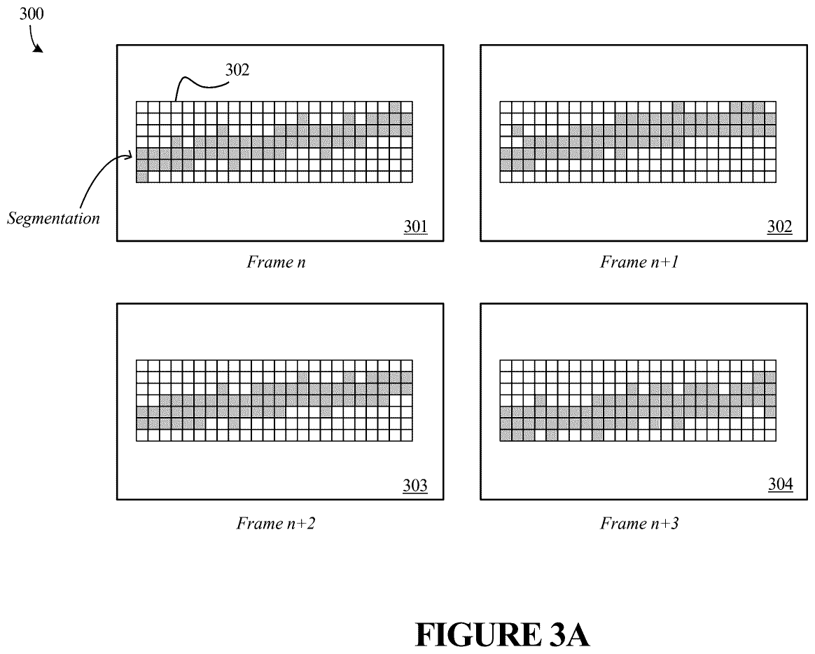

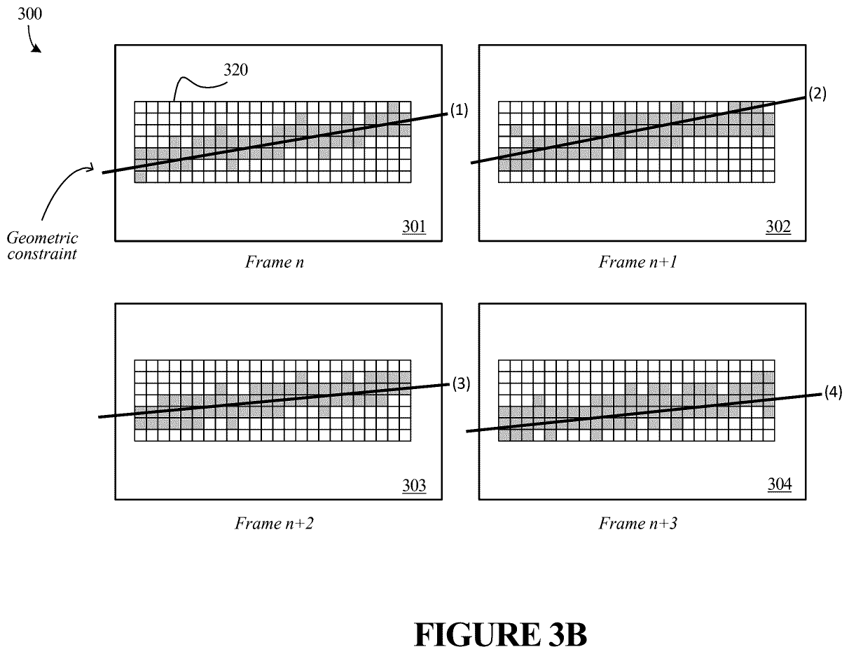

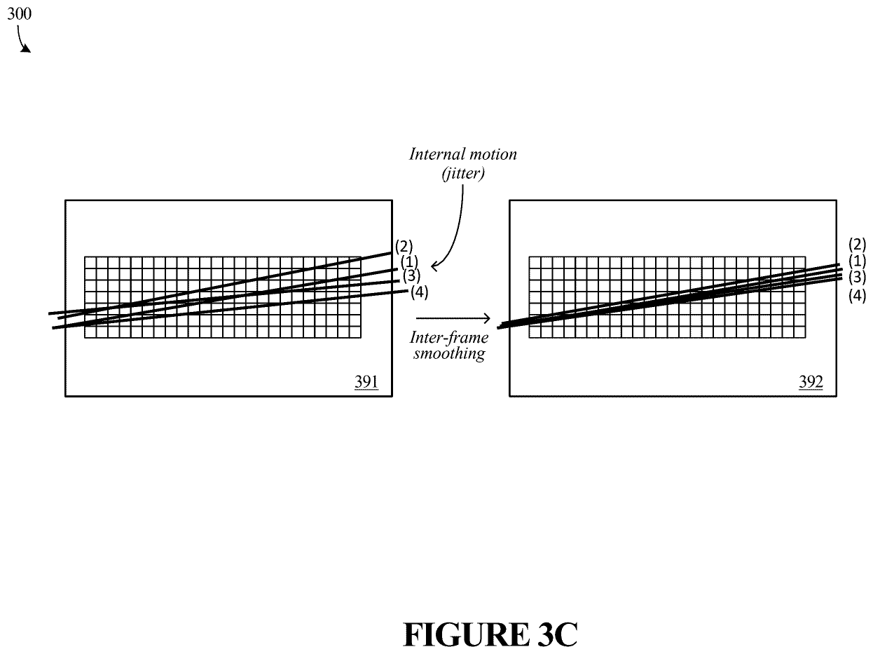

FIGS. 3A, 3B, and 3C illustrate process 300 for object tracking with intra-frame and inter-frame smoothing in an implementation. FIG. 3A includes a depiction of a sequence of frames n, n+1, n+2, and n+3, such as sequence of frames from a video. Within each frame, pixels 320 are a representation of the pixels or pixel mapping of a portion of the frame. In process 300, each of frames 301-304 has been processed by a segmentation model which performs a semantic segmentation to identify target objects for which the model has been trained. The segmentation of the target object may be a mask to which a graphical overlay is applied. As illustrated in FIG. 3A, a portion of the segmentation performed on each of the four frames indicates, with shaded pixels, a target object detected by the segmentation model.

After segmentation, intra-frame smoothing is applied to each of the frames by fitting a geometric constraint to the target object. In an implementation, a type of geometric constraint is determined based on the shape characteristics of the target object, e.g., linear, nonlinear, etc. As illustrated in FIG. 3B, for a target object with straight edges, a geometric constraint comprising straight lines (1), (2), (3), and (4) is applied to the target object. In various implementations, the linear geometric constraint is a linear regression calculated based on the pixels or rectangular coordinates of edges detected or segmented by the segmentation model. In some scenarios, the linear constraint is based on fitting a line between two points or landmarks of the target object, such as corners. Where the target object has nonlinear edges, a spline curve or higher order regression may be fitted to the object.

Continuing with process 300 in FIG. 3C, the sequence of frames is assessed for internal motion or jitter arising from the intra-frame smoothing. To illustrate the internal motion arising from intra-frame smoothing, lines (1)-(4) are shown together relative to the pixel mapping in frame 391. In an implementation, to assess the sequence of frames for internal motion, a shift in the position of the target objects from one frame to the next is computed. If the quantified shift falls within a range of values, the quantified shift is classified as internal motion and inter-frame smoothing is applied to smoothen the frame-to-frame shifting of the target object. The result of the inter-frame smoothing is depicted in frame 392, where the internal motion is suppressed by repositioning lines (2)-(4).

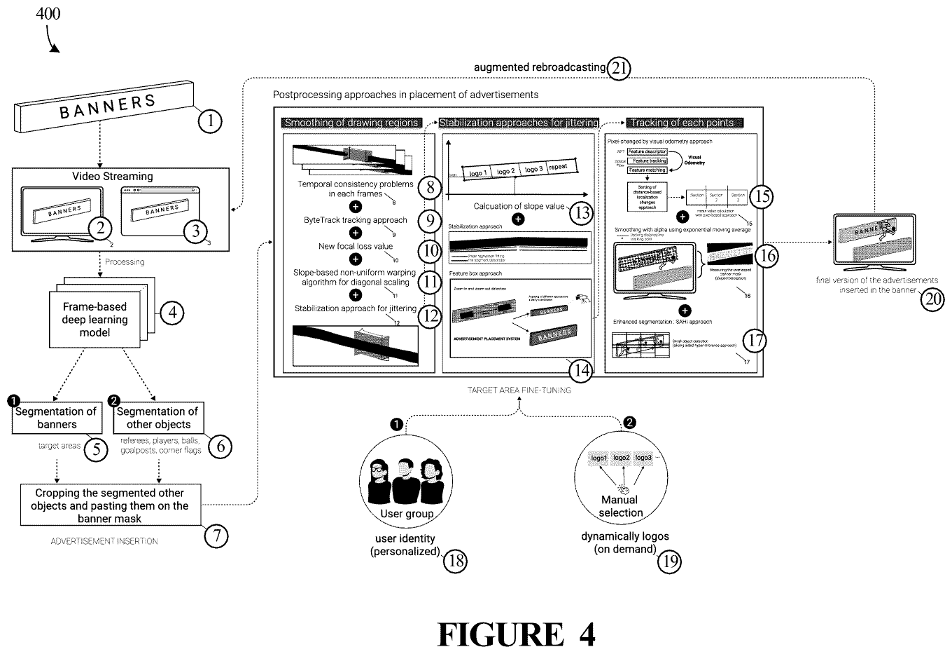

In various implementations, to smoothen the internal motion, an EMA is computed by which the position of the target object is to be adjusted. For example, in two consecutive frames of a sequence of frames, the position of the target object in the second frame is shifted from the position of the target object in the first frame. To apply EMA to a sequence of frames, a weighting factor is selected which adjusts the position of the second target object relative to the first target object. For the second and third frames, the weighting factor is applied to adjust the position of the third target object relative to the adjusted position of the second target object. The process continues for each pair of consecutive frames in the sequence. An implementation of inter-frame smoothing is illustrated in FIG. 4, discussed below.

In some scenarios, to perform inter-frame smoothing, a Kalman filter is applied which dynamically adjusts the weighting for adjusting the target object position based on both the observed measurements and the predicted state of the object. The Kalman filter operates by maintaining an estimate of the target object's position while incorporating new position measurements from each frame. At each step, the filter predicts the target object's next position based on its previous state and updates this prediction using the actual measured position, weighted by an uncertainty factor. The filter dynamically balances the influence of new measurements and historical estimates, reducing noise and improving tracking accuracy. By applying the Kalman filter to a sequence of frames, the motion of the target object is smoothed in a manner that adapts to variations in measurement reliability and object dynamics.

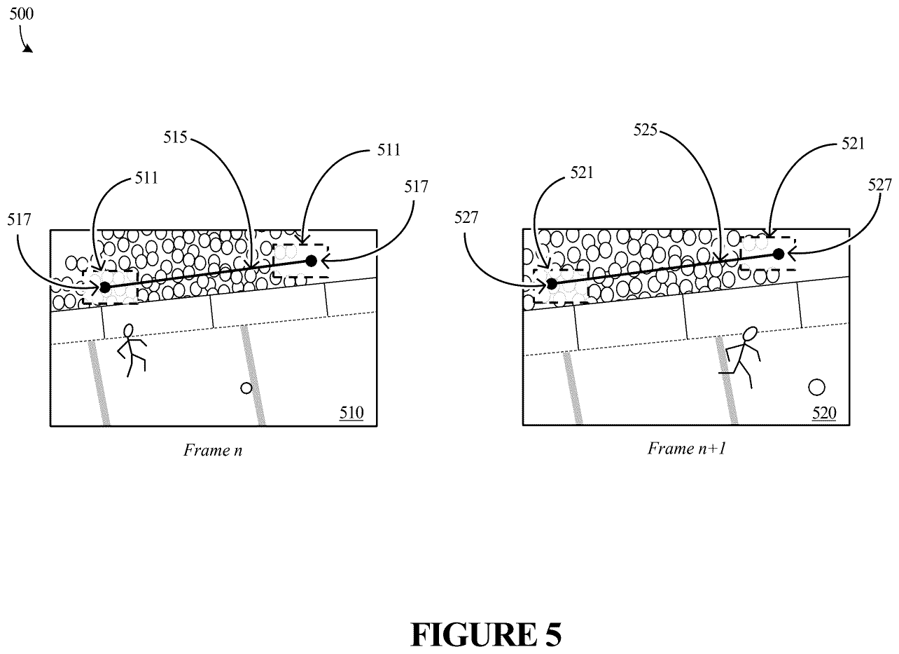

In some implementations of process 300, the external motion of the camera (e.g., zoom in/out, pan, sweep) is computed so it can be distinguished from any internal motion prior to applying inter-frame smoothing. For example, as illustrated in FIG. 5, the change in the relative position of features of two frames can be used to determine a zoom operation of the camera.

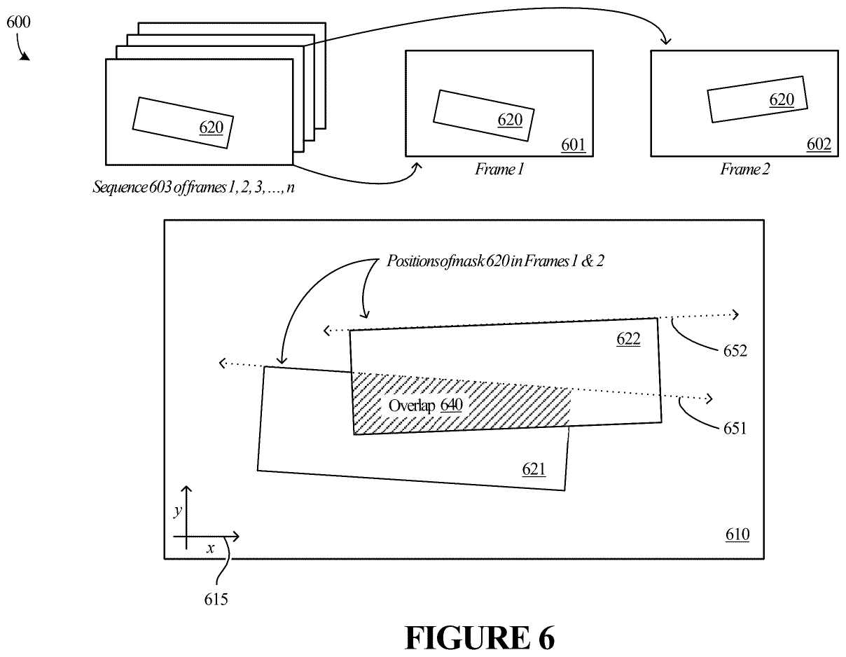

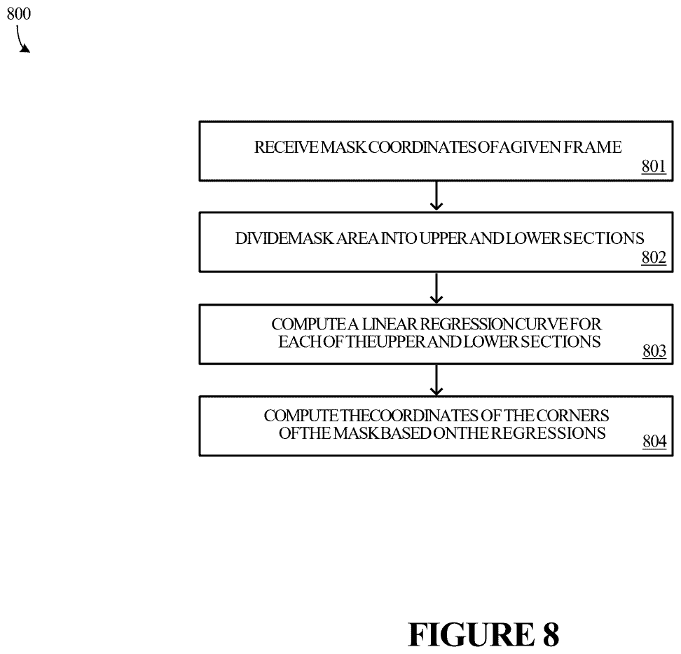

FIG. 4 illustrates workflow 400 for object segmentation and tracking in recorded video with dynamic camera operation in an implementation. Workflow 400 includes steps 1-21 as follows in the exemplary context of a televised broadcast of a sporting event (e.g., a football match) played on a playing field (e.g., pitch).
Step 1. The figure represents a billboard with original content, such as the observed region of interest advertisement (as illustrated, the word “BANNERS”). It is generally referred to as digital or static billboards or panels located at the edge of the pitches or other kinds of playing fields where advertisements are displayed. These panels are positioned in such a way that they can be seen by both the spectators in the stadium and the viewers in front of the television.
Step 2. When broadcasting sporting events such as football matches, television cameras often shoot the pitch from a wide angle so that the billboards are also prominently displayed across the screen. To deliver an appropriate camera feed, a television camera monitors a scene inside a desired field of view. Television broadcasting enables these advertisements to reach a wide audience, creating a great marketing opportunity for advertisers.
Step 3. Web browsers bring the flow of the match broadcast to the screen, while wide-angle shots of the pitch show the billboards on the sidelines. Viewers can observe these digital billboards while watching the match through web browsers, so the advertisements can reach a wide digital audience. Personalized advertisements are placed by performing the necessary processes on the video data to be received as livestreaming.
Step 4. This structure refers to a frame-based deep learning architecture. When processing livestream data, the neural network separates and processes it into images frame by frame. For this reason, due to the structure of the YOLOv8 algorithm, a layered structure is applied in the real-time inference phase. In an implementation, the deep learning model is YOLOv8 architecture which performs object segmentation.
Step 5. A frame-based segmentation approach is performed for the target structure, banner billboards. In this step, only the banner class is detected and masked. Using the coordinates of the segmentation masks, advertisement insertion is then performed.
Step 6. Since two-dimensional banner billboards will have advertisements placed on them, other objects need to be removed. Banner billboards may have many different objects, such as players, referees, flags, etc., in front of them. For this reason, all objects in the “other” category must be detected and separated with the frame-based deep learning model. In this step, the “other” class is detected and masked. Using the coordinates of the segmentation masks, advertisement insertion is then performed.
Step 7. “Other” objects detected for advertisement placement are identified, cropped and placed over the detected banner mask. At this stage, two separate models (“banner” and “other” objects segmentation) are run, first placing advertisements on the banner mask and then placing the “other” segmented objects on top of these advertisements.
Step 8. The frame-based masks generated by the segmentation task are constantly changing depending on the banner areas in the video. This leads to the problems with temporal inconsistency in each frame. Examples of this are discontinuous and incomplete appearances that may occur in some masks.
Step 9. During frame transitions, there may be mask changes that are predicted. Therefore, the ByteTrack algorithm is used to establish a meaningful connection between previous and subsequent frames. The ByteTrack algorithm is a multi-object tracking (MOT) algorithm which enhances object tracking by associating a confidence score with every detection box, rather than discarding low-confidence detection boxes as in other MOT algorithms.
Step 10. Apply modulative cross-entropy technique to avoid class imbalance problem in object detection tasks. The modulative cross-entropy technique produces a dynamically scaled cross-entropy loss where the scaling factor decays to zero as confidence in the correct class increases.
Step 11. A linear regression algorithm is applied to classify the top and bottom lines of a banner mask from which a slope value can be calculated. This approach results in smoother curves by providing a non-uniform warping process that depends on the slope value. However, the various logos on the banner are fixed. An implementation of applying linear regression curves to a segmented object such as a mask is illustrated in FIG. 8, discussed infra.
Step 12. “Jittering” describes the vertically continuous play in banner masks. For the jittering problem, the left and right center coordinates of the banner that require stabilization are identified, and the lines (e.g., top and bottom lines) are smoothed with linear regression fitting curves.
Step 13. The number of logos to be placed are calculated based on the width and height of the banners. Accordingly, the dynamic logos to be placed manually (in step 19) will be calculated and placed according to the width-height values. Dynamic advertisements can be repeated as many times as the desired value.
Step 14. The zoom-in and zoom-out technique is applied according to the rate at which the distance in the camera zooms in or out. The zoom-in/out technique shows a strong sensitivity to movement. According to this approach, it is assumed that as the camera moves away (i.e., zooms out), the zoom value becomes smaller, while as the camera moves closer (i.e., zooms in), the zoom value becomes larger. After defining the zoom-in and zoom-out techniques, different advertisement placement approaches are applied. An implementation of quantifying a camera zoom operation based on features detected in a frame is depicted in FIG. 5, discussed infra.
Step 15. Scale-Invariant Feature Transform (SIFT) and Optical Flow algorithms are applied to overcome the jittering problem. A tracking process is performed by identifying the features with the feature descriptor in the video patterns and feature-matching is performed accordingly. The banner region is divided, in this example, into three structures, and a distance-based positioning approach is applied by calculating the mean value. SIFT detects and describes key points in an image which are invariant to scale and rotation. Optical Flow estimates the motion of objects, edges, or pixels between consecutive frames in a video or image sequence.
Step 16. The overlap in mask coordinates between the previous frame and the next frame is measured. The EMA function is generated, and an alpha factor is applied to smooth the change in intersection and slope. By applying this factor, a more stable linear regression line for placing the banner is obtained. An implementation of applying an EMA function to smooth internal motion is illustrated in FIG. 6, discussed infra.
Step 17. Since it can be difficult to detect small players in football matches due to a far angle, the Slicing Aided Hyper Inference (SAHI) approach is processed on this structure. With SAHI on the frame-based deep learning model, players and other objects are detected.
Step 18. A targeted or personalized approach to advertisement selection addresses a specific user/audience, the users' identity information is kept and the advertisements they desire are displayed on the banner.
Step 19. In an on-demand approach to advertisement selection, a manual advertisement placement is done when no user/audience information is available or required. Upon request, the user can select the advertisements they want and place them on the banner.
Step 20. When the action of placing advertisements on the banners is desired to look realistic for visual cohesion, an LED board structure or effect can be applied. A billboard structure with an LED board effect on the banners is depicted.
Step 21. Augmented recordings are returned to live broadcasts with the placed version after the advertisement placement process. This process is called augmented as the structures taken from live broadcasts are continuously processed and re-presented to the user/audience.

FIG. 5 depicts operational scenario 500 for a process for detecting and estimating a zoom in/out camera operation in a video feed in an implementation. Operational scenario 500 includes successive video frames 510 and 520, feature boxes 511 and 521; centroids 517 and 527, and feature distances 515 and 525. In a brief example of the zoom detection and estimation process, a video feed is captured which includes successive frames 510 and 520. Distinctive features are identified in feature boxes 511 of frame 510 and feature boxes 521 of frame 520. Centroids 517 and 527 are computed based on the distinctive features of each of feature boxes 511 and 521, respectively. Next, feature distances 515 and 525 are computed between centroids 517 and 527. By comparing feature distances 515 and 525, the external motion arising from the detected zoom in/out operation can be quantified so it can be removed from or compensated for with respect to any internal motion between frames 510 and 520.

In an implementation, to detect and estimate the zoom operation for inter-frame smoothing, the zoom operation is quantified between pairs of frames (e.g., two successive frames). To quantify the zoom operation, for each frame, a feature distance (i.e., Euclidean distance) is computed between features which occur in both frames. By comparing the feature distances of the pair of frames, a zoom value can be computed to estimate the zoom in/out operation. With the zoom operation quantified, the external motion associated with the zoom effect can be compensated for or subtracted from any internal motion in the inter-frame smoothing operation.

To compute the feature distance for a given frame of the two frames, two feature boxes are positioned over the given frame outside of any targeted or segmented objects in the frame. The location coordinates (e.g., rectangular coordinates) of the center points or centroids of each feature box are calculated based on features detected in the respective features boxes. In an implementation, the descriptive or distinctive feature points from the scene in a feature box are identified or extracted using a feature extraction algorithm (e.g., SIFT, SURF (Speeded-Up Robust Features), ORB (Oriented FAST and Rotated BRIEF), FAST (Features from Accelerated Segment Test), BRIEF (Binary Robust Independent Elementary Features), Harris Corner Detector). Feature extraction algorithms analyze local variations in pixel intensity and identifying regions with high contrast or unique geometric structures. The identified features are then described mathematically (using feature descriptors) to enable matching between frames, even under changes in focal length (i.e., scale), rotation, or lighting.

Next, with the location coordinates of the center points or centroids of the feature boxes computed, a distance between the center points is computed for the given frame. For example, the distance may be computed in terms of a number of pixels. With the feature distances computed, if the feature distance increases from one frame to the next, this indicates that the camera has zoomed in (i.e., the focal length shortened). Conversely, if the feature distance decreases from one frame to the next, this indicates that the camera has zoomed out (i.e., the focal distance lengthened). (No change or no appreciable change in feature distance indicates that no zoom in/out has occurred.)

In some implementations, a CNN-based object detection model (e.g., YOLO, Faster R-CNN, or SSD) can be trained to identify specific bounding boxes comprising or including feature boxes or regions of interests (ROIs) in a frame. The bounding boxes can dynamically adapt to changes in the scene from one frame to the next irrespective of any zoom effect. Once the bounding boxes are detected, the ROIs can be aligned with these regions to extract feature points. For example: the bounding boxes can be used as ROI boundaries, and the centroid of features can be calculated within each bounding box. As the bounding boxes change in size and position across a succession of frames, the changes to the position and dimensions of the bounding boxes can be used to quantify the zoom in/out operation-to wit, if the bounding boxes shrink from one frame to the next, the camera has zoomed out and the focal length lengthened, etc.

In a given frame, the feature boxes of a first frame (of a pair of frames) may be positioned at specific locations in the frame, such as at specified distances relative to the upper-left and lower-right corners of the frame. In some scenarios, the feature boxes may be positioned in a background region of the frame, for example, as detected by a segmentation model. The feature boxes may be sized in proportion with the dimensions of the frame, e.g., one-sixth the width of the frame by one-sixth the height of the frame. The feature boxes may be positioned to ensure that there is no overlap in either dimension (e.g., vertical or horizontal), ensuring that the distance between the center points is based on difference values in both dimensions rather than a single dimension.

In an implementation, to identify and track features or feature boxes across multiple frames, a process is implemented to classify features in a frame image, identify reliable features for analyzing camera movement, and discard unreliable or outlier features. To identify reliable key points and features in the images are extracted with the SIFT algorithm. The SIFT algorithm identifies key points by analyzing the frame images at different scales and generates a feature vector based on the orientation and size information of the regions around the key points. The extracted features are subjected to tracking and matching using the Lucas-Kanade optical flow algorithm. The Lucas-Kanade algorithm detects the direction (e.g., left or right turn) and magnitude of the camera's movement by analyzing pixel movements in consecutive frames. After matching the extracted features, the distances between feature points are calculated and ranked. Based on the distance values, the features are categorized into three main regions. In the first region, points that did not move or moved very little are classified as “outliers.” In the third region, points that moved excessively are also identified as “outliers.” Points in the middle region are considered “normal” and reliable and are included in computing a centroid of a feature box and computing a feature distance between centroids.

FIG. 6 illustrates operational scenario 600 for detecting and quantifying inter-frame jitter or internal motion for inter-frame smoothing of a video feed in an implementation. Operational scenario 600 includes frames 601 and 602 of sequence 603, frame area 610, coordinate system 615, mask 620 at first position 621 and second position 622, overlap 640, and linear regression lines 651 and 652 coinciding with the top boundaries of first position 621 and second position 622, respectively.

In operational scenario 600, a segmentation model (not shown) determines the positions of mask 620 in frames of sequence 603. A process of intra-frame smoothing is applied to the frames in sequence 603 according to the technology disclosed herein. Subsequent to the intra-frame smoothing, the positions of mask 620 in the frames of sequence 603 are compared and a determination is made as to whether to modify or smooth a position of mask 620 to address any jitter which randomly occurs or which arises from the intra-frame smoothing. To illustrate the shift in position of mask 620 across two successive frames, first position 621 and second position 622 are depicted together in frame area 610; overlap 640 illustrates the overlapping area of first position 621 and second position 622. (Note that the shift in mask position from position 621 to position 622 in FIG. 6 is exaggerated for clarity.)

To identify or isolate random noise or visual jitter in the appearance of mask 620 in the transition from frame 601 to 602, first position 621 and second position 622 are compared to determine whether a shift in the position of mask 620 is due to camera motion or if it is instead due to jitter. In an implementation, to classify the position shift, a metric which quantifies the relative size (e.g., area) of overlap 640 (e.g., an overlap percentage) is computed for first position 621 and second position 622. Depending on whether the overlap metric exceeds a threshold value, an action to smooth the position shift may be taken. For example, when the overlap metric is above the threshold (indicating a relatively insignificant shift in mask position), the shift is attributed to jitter, and an action may be initiated to smooth the jitter between frames. In some scenarios, when the overlap metric is very high (e.g., greater than 98%), a second threshold may be used to determine that the jitter is so minimal that no action need be taken. For example, when the overlap metric falls within a specified range of values (e.g., 98.0% to 99.8%), this indicates that a smoothing operation is to be applied. When the overlap metric is below the threshold (indicating an appreciable shift in mask position), the shift in mask position is attributed to external (i.e., camera) movement and no smoothing operation is performed. In some cases, when the shift is attributed to camera movement, the camera movement or motion may be estimated based on the detected shift in mask position.

When a shift in mask position is attributed to jitter or noise, a process is applied to smooth the transition of the mask position from one frame to the next. To smooth the transition, a linear regression lines 651 and 652 (e.g., y=mx+b) are determined based on the top edges or boundaries of the two successive mask positions according to coordinate system 615. Next, an alpha (α) factor (a numerical value between 0 and 1) is selected for computing new, “smoothed” values for the slope m and for the y-axis intercept b of the regression lines. The selection of alpha determines the smoothness or abruptness of the transition.

Applying the alpha factor to linear regression lines 651, 652, and so on for the multiple frame-to-frame transitions of sequence 603 reduces the jitter or noise and stabilizes the positioning of mask 620 for the sequence. In a sequence of frames to which an alpha factor is applied, the smoothing effect of the alpha factor multiplier accumulates in an exponential manner with each additional frame in the sequence. As the effect of the alpha factor is dampened with each additional frame, this causes the smoothing effect to be reduced and the smoothed mask position to approach to its non-smoothed position with each additional frame.

To demonstrate the application of the alpha factor for a sequence of frames, m₁ represents the slope of linear regression line 621 of Frame 1; m₂ represents the slope of linear regression line 652 for Frame 2; and so on. (Linear regression lines 621, 622, and so on may be determined during a process of intra-frame smoothing according to the technology disclosed herein, such as the application of a linear geometric constraint to a segmented object.) Applying the alpha factor, new or updated slope values m_{smoothed(n)} can be calculated for the transition to frame n from frame n−1:

$$\begin{matrix}{m}_{smoothed ( 1 )} = {m}_{1} \\ {m}_{smoothed ( 2 )} = α {m}_{2} + ( 1 - α ) {m}_{smoothed ( 1 )} \\ {m}_{smoothed ( 3 )} = α {m}_{3} + ( 1 - α ) {m}_{smoothed ( 2 )} \\ … \\ {m}_{smoothed ( n )} = α {m}_{n} + ( α ) {m}_{smoothed ( n - 1 )} \\ …\end{matrix}$$

A similar process of smoothing is applied to the intercepts b₁, b₂, . . . of linear regression lines 651, 652, and so on. In some scenarios, the linear regression lines which are smoothed may be the bottom edge, left edge, or right edge of mask 620. In still other scenarios, the linear regression lines subject to inter-frame smoothing are computed at midpoints of two opposing sides, such as the midpoints of the left and right sides of the mask boundaries.

To measure the overlap in mask position between the previous frame and the next frame, in an implementation, the overlap metric is computed as a percentage based on Intersection over Union (IoU), that is, the overlap area (intersection) with respect to the area of the union of the two overlapping masks. In some cases, the overlap percentage is based on the overlap area with respect to the area of a single mask or other fixed area.

In some implementations, inter-frame smoothing is applied to sequence 603 using a Kalman filter process. In a Kalman filter process, a Kalman filter is applied to reduce internal motion or jitter in the appearance of a target object across multiple frames in a video sequence. The Kalman filter operates as a recursive estimation algorithm that combines prior predictions with new observations to produce a smoothed estimate of the object's position and motion.

At each frame, the Kalman filter maintains an internal state that represents the estimated position and velocity (i.e., rate of change of position from one frame to the next) of the target object. The filter operates in two main phases: a prediction phase and an update phase. In the prediction phase, the filter projects the target object's position forward based on a motion model, typically assuming a constant velocity or acceleration. In the update phase, the filter incorporates the actual observed position of the target object in the current frame, weighting the new measurement based on an uncertainty factor that accounts for measurement noise and dynamic changes in object motion.

By dynamically adjusting the weight assigned to new observations, the Kalman filter smooths the trajectory of the target object across frames, reducing fluctuations arising from internal motion or noise. As a result, the appearance of the target object remains stable and visually consistent throughout the video sequence.

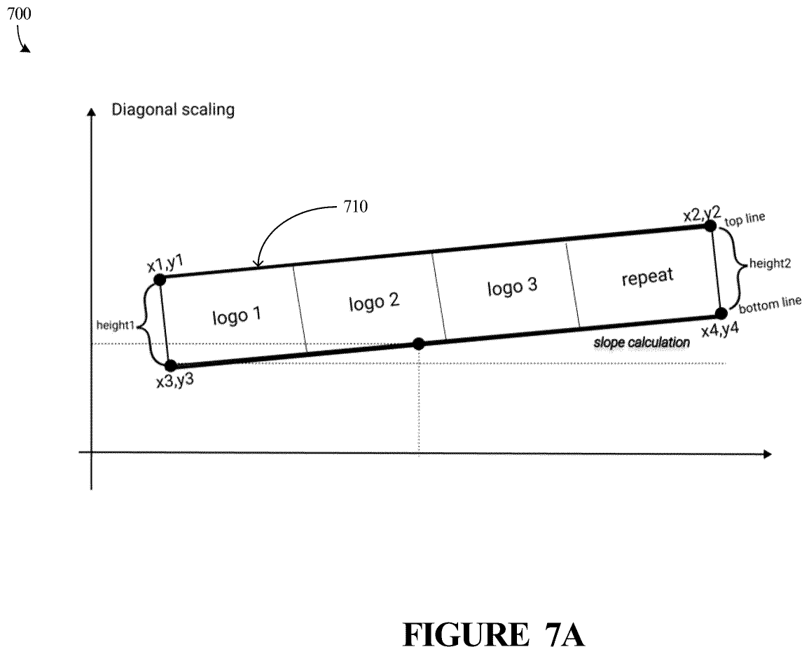

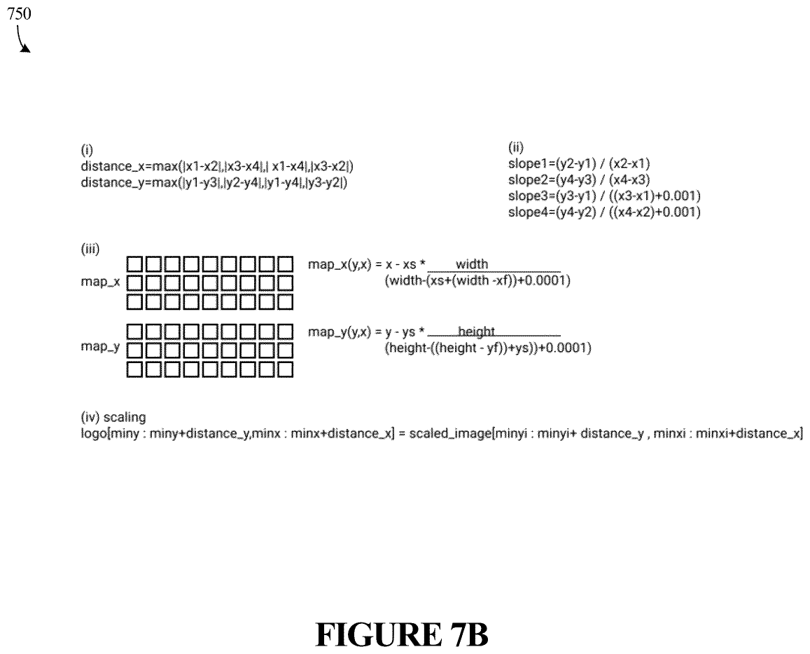

FIGS. 7A and 7B illustrate a process for slope-based non-uniform warping for intra-frame smoothing in an implementation. The slope-based non-uniform warping process can be applied when the mask areas may be curved or otherwise distorted due to the perspective of the camera. To address the nonlinearity of the mask area for placing the overlay, a process is applied to classify the top and bottom lines by calculating a slope value. Two points (e.g., corners of the mask) are identified as average coordinates for x and y coordinates. A linear regression algorithm is applied to classify the upper and lower lines from which a slope value can be extracted; the linear regression is then used to remove outliers from these lines. Thus, smoother curves are obtained by providing a non-uniform warping process that depends on the slope value. In addition, the term “non-uniform” in this context refers to a process that is not applied evenly or equally across the entire area. Finally, the slope of the mask area is calculated and the overlays scaled accordingly. Notably, any high-value visual elements (e.g., logos) of the overlay may be superimposed on the mask area independently of the warping process to prevent warping of the visual elements.

Geometric model 700 of FIG. 7A depicts elements of a linear constraint as applied in an intra-frame smoothing process in an implementation. In FIG. 7A, a banner or banner graphic is overlain on mask 710 in a frame of a video or sequence of frames. Geometric model 700 depicts a framework for computing the slope of top and bottom lines of mask 710 based on the coordinates of the detected corners of the banner area. In equations 750 of FIG. 7B, various slope and distance quantities are calculated based on the Cartesian coordinates of the detected corners of the banner area.

Equations 750 also includes equations for map coordinates of points, areas, or pixels in the banner area. Equations 750 include computing a maximum x and y distance across mask 710 based on the coordinates of the corners. Equations 750 also include computing the slopes of the sides (e.g., top, bottom, left, right) of mask 710 based on the corner coordinates. Equations 750 also compute a scaling of the dimensions for a logo of an overlay based on the dimensions of the mask area. Equations 750 also includes a scaling equation for scaling a logo based on image scaling.

FIG. 8 illustrates process 800 for fitting linear regression curves to a segmented mask of a video frame in an implementation. In process 800, to stabilize internal motion arising in a sequence of frames of a video feed, for a given frame, the point coordinates from a mask are divided into upper and lower sections, and each section is analyzed separately. By applying linear regression for the upper section, changes to coordinates in each region can be smoothed and stabilized independently.

In step 801, the coordinates of points of a mask are received for a given frame of a sequence of frames.

In step 802, the points of the mask are divided into two distinct sections: upper and lower. The point coordinates within each section are isolated for individual analysis. This separation allows for targeted smoothing of coordinate fluctuations, ensuring more precise adjustments in each region of the banner.

In step 803, linear regression is applied independently to the coordinate data of the upper and lower sections. Fitting a regression line to the data in each section reduces irregular variations in point positions across consecutive frames. The smoothing effect provided by linear regression minimizes jitter, resulting in a more stable and gradual change in the banner's motion.

In step 804, using the smoothed regression fits from both the upper and lower sections, four primary corner coordinates of the banner are calculated: right top, left top, right bottom, and left bottom. The coordinates of the four primary corners define the banner's geometric boundaries and are used to reconstruct its position and shape in a stabilized manner.

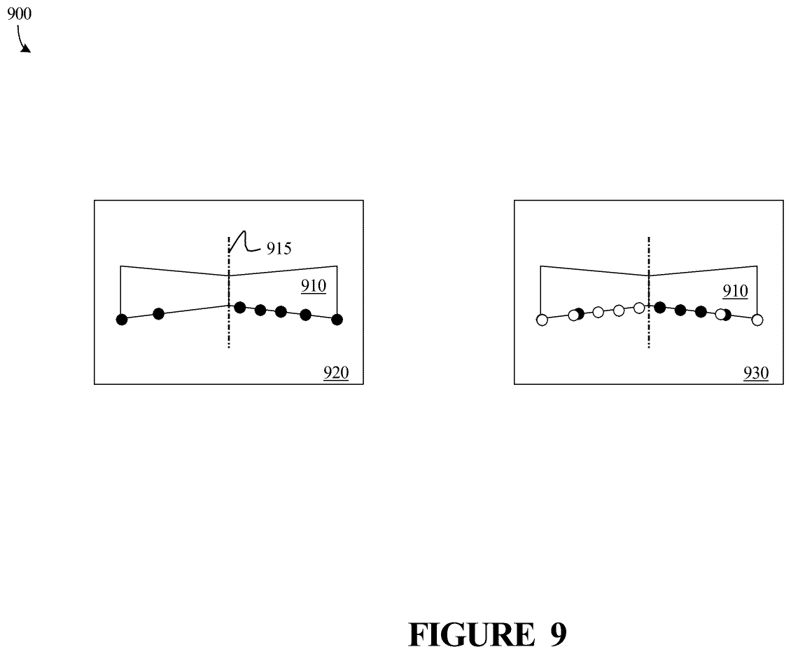

FIG. 9 illustrates process 900 for a custom reversed function technique for intra-frame smoothing in an implementation. Process 900 may be used to apply a geometrical constraint to a mask, for example, to apply a linear regression constraint to a banner mask. (Note that process 900 can be used in addition or as an alternative to the process described in FIGS. 7A and 7B.) In an implementation, in a video feed, the boundaries of a mask area (e.g., a banner area) may be nonlinear, e.g., slightly curved. When fitting the linear regression line based on the mask coordinates (which represent the curve), this can cause inconsistencies across multiple frames. For example, in some frames, a higher density of points from the segmentation mask lies on the right side of the curve, while in others, the majority of points appear on the left side. Frame 920 of FIG. 9 depicts a mask 910, where the nonlinear bottom edge is delineated with more points (black dots) on the right side than on the left. This discrepancy causes the linear regression line, representing the banner's coordinates, to jitter across frames.

To address this issue, in process 900, a “point reversal” method is applied: the points on the left side of the curve are mirrored to the right and vice versa. As depicted in frame 930 of FIG. 9, the points delineating the lower edge of mask 910 are mirrored across vertical axis 915 (as indicated by the white dots) so that the dots of the left and right sides are now balanced or symmetric. This adjustment was intended to balance the curve, allowing for a more stable linear regression fit across frames without jittering. In some scenarios, implementing a point reversal requires mirroring the points across a slanted axis of symmetry (rather than vertical) which can vary depending on the specific overlay. With the original and mirrored points, a linear regression curve can be fitted to the linear edge of the mask that will be more stable than using just the original points alone.

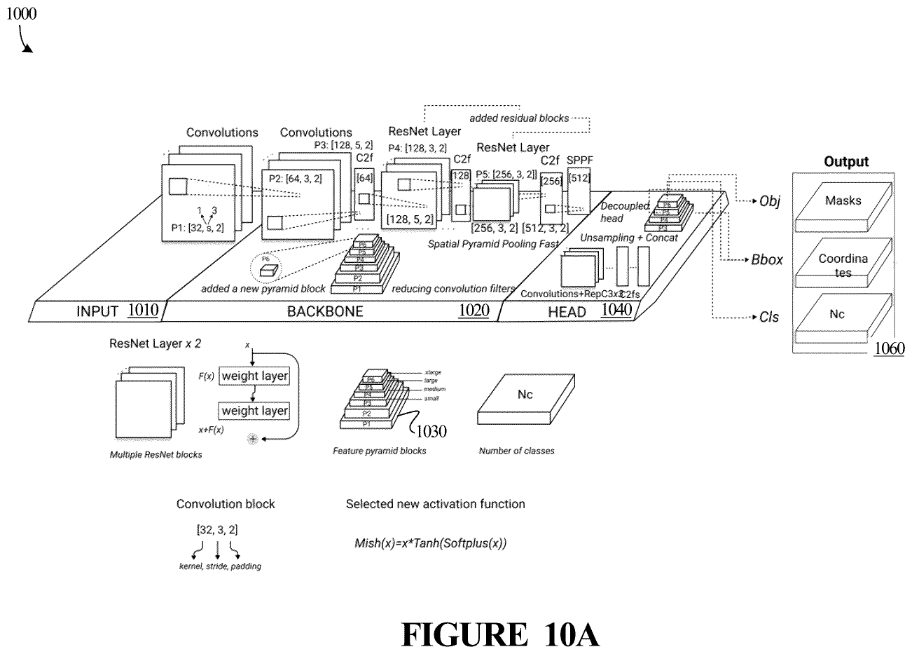

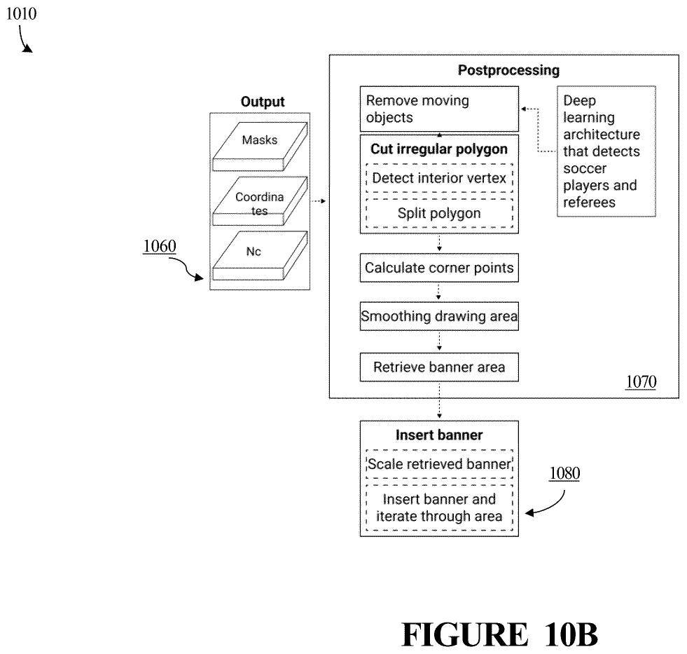

FIGS. 10A and 10B illustrate a neural network architecture for object segmentation and tracking in dynamic video in an implementation. FIG. 10A includes input 1010, backbone 1020, pyramid 1030, and head 1040. Input 1010 represents the initial image or data fed into the model, preprocessed for optimal compatibility. Backbone 1020 is responsible for feature extraction, utilizing convolutional layers with specified kernel sizes, strides, and padding parameters to capture spatial hierarchies and patterns in the data. Residual Network (ResNet) layers are prominently used here, introducing residual connections to facilitate efficient training by mitigating the vanishing gradient problem. The C2f (Coarse-to-Fine) module enhances feature representation by refining multi-scale features through lightweight computations, improving the balance between performance and computational efficiency.

Pyramid 1030, often part of the neck, integrates multi-scale features from the backbone. It combines high-resolution spatial information with low-resolution semantic details to ensure robust detection of objects of varying sizes. The SPPF (Spatial Pyramid Pooling—Fast) module pools feature at different scales, increasing the receptive field while preserving computational efficiency. Finally, head 1040 processes these aggregated features to output 1060 which includes predictions for bounding boxes (coordinates), object classifications, and segmentation masks.

FIG. 10B includes output 1060, postprocessing flow 1070, and banner insertion process 1080. Postprocessing flow 1070 includes removing moving objects (e.g., soccer players, referees) detected by the deep learning model.

To prevent the images within the overlays from being distorted in accordance with the mask distortion (due to camera perspective, etc.), specific visual elements of the overlay may be overlaid on the mask area without applying any warp.

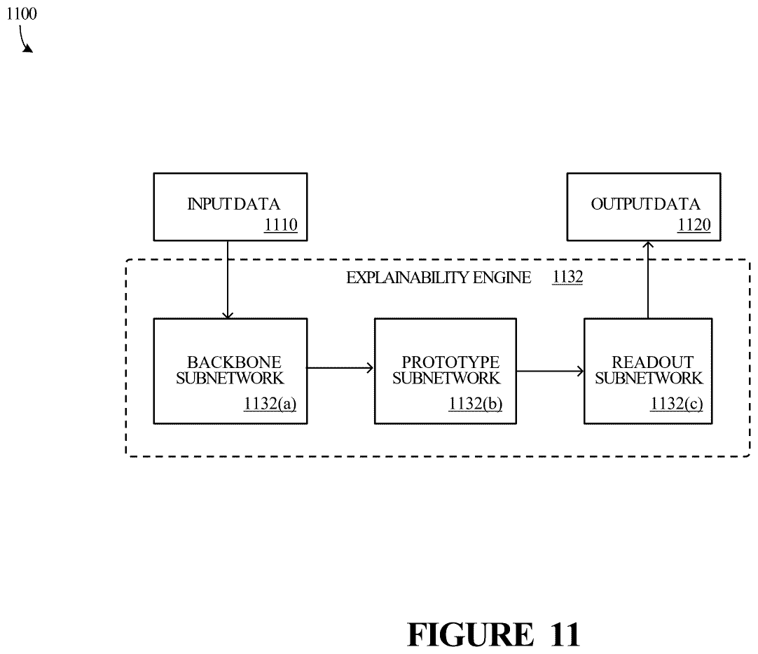

In some implementations, the neural network architecture for object segmentation and tracking in video can include a CNN with an incomplete sequence of active convolutional layers (“incomplete CNN”). The incomplete CNN can include an explainability engine for enhanced interpretability of the output of the incomplete CNN, an implementation of which is illustrated in FIG. 11 and discussed below. Because the use of an incomplete CNN can introduce inaccuracies in the segmentation of the video frames (due, for example, to a low fidelity of the CNN), the intra-frame smoothing processes disclosed herein can be used to compensate for such inaccuracies and imperfect segmentation.

FIG. 11 illustrates a neural network architecture for object segmentation and tracking in video in an implementation. Neural network architecture 1100 includes explainability engine 1132 including backbone subnetwork 1132(a), prototype subnetwork 1132(b), and readout subnetwork 1132(c). Neural network architecture 1100 may be implemented in on a computing device of which computing system 1200 is representative.

For artificial intelligence-based image processing, explainability engine 1132 can enhance the interpretability of deep learning models by grounding classification decisions in identifiable, interpretable features extracted from training data, ensuring that AI-driven decisions are traceable and understandable. Explainability engine 1132 includes a structured system comprising three interconnected subnetworks: a backbone subnetwork for feature extraction, a prototype subnetwork for mapping input features to learned prototypes, and a readout subnetwork for generating interpretable classifications.

In an implementation, backbone subnetwork 1132(a) processes an input image or frame through multiple convolution layers to extract features. Backbone subnetwork 1132(a) constrains the receptive fields of active layers of the convolution layers to produce localized feature embeddings rather than global representations. By reducing the receptive field size, backbone subnetwork 1132(a) preserves spatial relationships between image regions and their corresponding learned prototypes, thereby improving interpretability without significantly compromising accuracy. Backbone network 1132(a) may employ a mix of standard convolutional layers, Rectified Linear Unit (ReLU) activations, and pooling layers to process input images efficiently.

In an implementation, prototype subnetwork 1132(b) performs feature-to-prototype comparisons. During training, prototype subnetwork 1132(b) learns a set of prototypical parts from labeled data, where each prototype represents a distinctive feature of a specific class. The prototypes are stored as low-dimensional embeddings, which prototype subnetwork 1132(b) later compares to the extracted feature embeddings from input images. Using a distance function such as cosine similarity, prototype subnetwork 1132(b) generates a similarity map that quantifies the correlation between image patches and learned prototypes. Prototype subnetwork 1132(b) then applies max pooling to retain the strongest matching regions, ensuring that the final classification decision is based on the most relevant image segments.

In an implementation, readout subnetwork 1132(c) translates the similarity scores into a final classification output. Readout subnetwork 1132(c) aggregates prototype-based similarity scores within each class and applies a softmax activation function to compute class probabilities. Readout subnetwork 1132(c) explicitly associates classification decisions with prototype matches, thereby generating explanatory outputs alongside the predicted class. Readout subnetwork 1132(c) may also include a fully connected layer with positive and negative weights to reinforce class-specific prototype associations while minimizing irrelevant prototype contributions.

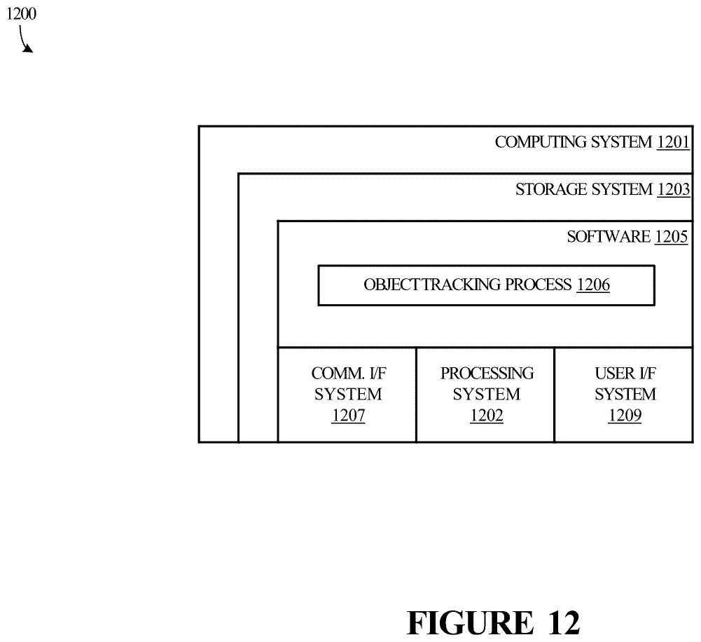

FIG. 12 illustrates computing device 1201 that is representative of any system or collection of systems in which the various processes, programs, services, and scenarios disclosed herein may be implemented. Examples of computing device 1201 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 1201 may be implemented as a single apparatus, system, or device or may be implemented in a distributed manner as multiple apparatuses, systems, or devices. Computing device 1201 includes, but is not limited to, processing system 1202, storage system 1203, software 1205, communication interface system 1207, and user interface system 1209 (optional). Processing system 1202 is operatively coupled with storage system 1203, communication interface system 1207, and user interface system 1209.

Processing system 1202 loads and executes software 1205 from storage system 1203. Software 1205 includes and implements object tracking process 1206, which is (are) representative of the object tracking processes discussed with respect to the preceding Figures, such as process 200 and workflows 100 and 300. When executed by processing system 1202, software 1205 directs processing system 1202 to operate as described herein for at least the various processes, operational scenarios, and operational sequences discussed in the foregoing implementations. Computing device 1201 may optionally include additional devices, features, or functionality not discussed for purposes of brevity.

Referring still to FIG. 12, processing system 1202 may comprise a micro-processor and other circuitry that retrieves and executes software 1205 from storage system 1203. Processing system 1202 may be implemented within a single processing device but may also be distributed across multiple processing devices or sub-systems that cooperate in executing program instructions. Examples of processing system 1202 include general purpose central processing units, graphical processing units, application specific processors, and logic devices, as well as any other type of processing device, combinations, or variations thereof.

Storage system 1203 may comprise any computer readable storage media readable by processing system 1202 and capable of storing software 1205. Storage system 1203 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1203 may also include computer readable communication media over which at least some of software 1205 may be communicated internally or externally. Storage system 1203 may be implemented as a single storage device but may also be implemented across multiple storage devices or sub-systems co-located or distributed relative to each other. Storage system 1203 may comprise additional elements, such as a controller, capable of communicating with processing system 1202 or possibly other systems.

Software 1205 (including object tracking process 1206) may be implemented in program instructions and among other functions may, when executed by processing system 1202, direct processing system 1202 to operate as described with respect to the various operational scenarios, sequences, and processes illustrated herein. For example, software 1205 may include program instructions for implementing an object tracking process as described herein.

In particular, the program instructions may include various components or modules that cooperate or otherwise interact to carry out the various processes, workflows, operational sequences, and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1205 may include additional processes, programs, or components, such as operating system software, virtualization software, or other application software. Software 1205 may also comprise firmware or some other form of machine-readable processing instructions executable by processing system 1202.

In general, software 1205 may, when loaded into processing system 1202 and executed, transform a suitable apparatus, system, or device (of which computing device 1201 is representative) overall from a general-purpose computing system into a special-purpose computing system customized to support object tracking in an optimized manner. Indeed, encoding software 1205 on storage system 1203 may transform the physical structure of storage system 1203. The specific transformation of the physical structure may depend on various factors in different implementations of this description. Examples of such factors may include, but are not limited to, the technology used to implement the storage media of storage system 1203 and whether the computer-storage media are characterized as primary or secondary storage, as well as other factors.

For example, if the computer readable storage media are implemented as semiconductor-based memory, software 1205 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1207 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1201 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. An image processing system, comprising:
a processor coupled with stored instructions, wherein the stored instructions, when executed by the processor, direct the image processing system to:
collect a sequence of frames of a video of a scene;
process the sequence of frames with a neural network trained to segment and track a background object in the scene;
modify the segmented object in at least some of the frames by intra-frame smoothing, wherein intra-frame smoothing comprises enforcing a geometrical constraint on a shape of the segmented object;
estimate an internal motion of the segmented object in the sequence of frames caused by the intra-frame smoothing;
perform an inter-frame smoothing of the internal motion of the segmented object in the sequence of frames to smoothly track the segmented object in the video; and
perform a downstream task on the tracked segmented object.

2. The image processing system of claim 1, wherein the stored instructions further direct the image processing system to:
estimate an external motion in the sequence of frames caused by an operation of a camera filming the video; and
estimate the internal motion of the segmented object caused by the intra-frame smoothing based on a location of the segmented object in each frame of the sequence of frames.

3. The image processing system of claim 2, wherein to estimate the external motion, the stored instructions direct the image processing system to estimate the external motion based on metadata of the video.

4. The image processing system of claim 2, wherein to estimate the external motion, the stored instructions direct the image processing system to estimate the external motion based on a pixel correspondence of multiple pixels associated with the segmented object, wherein the multiple pixels include pixels outside of the segmented object.

5. The image processing system of claim 2, wherein to perform the intra-frame smoothing, the stored instructions direct the image processing system to enforce a geometric constraint on the segmented object based on a linear regression of linear edges of the segmented object.

6. The image processing system of claim 2, wherein the inter-frame smoothing is performed using a Kalman filter tracking the segmented object using a motion model and a measurement model, wherein the motion model includes the external motion and wherein the measurement model includes measurements of pixels of the segmented object modified with the intra-frame smoothing.

7. The image processing system of claim 1, wherein the neural network is an incomplete convolutional neural network (CNN) of low fidelity, such that the intra-frame smoothing compensates for distortions caused by operations of a camera filming the video and inaccuracies of segmentation caused by the low fidelity of the incomplete convolutional neural network.

8. The image processing system of claim 1, wherein the background object is a banner having a rectangular shape, and wherein the downstream task includes replacing signage of the banner with an overlay comprising a different signage.

9. A method of operating an image processing system, comprising:
collecting a sequence of frames of a video of a scene;
processing the sequence of frames with a neural network trained to segment and track a background object in the scene;
modifying the segmented object in at least some of the frames by intra-frame smoothing, wherein intra-frame smoothing comprises enforcing a geometrical constraint on a shape of the segmented object;
estimating an internal motion of the segmented object in the sequence of frames caused by the intra-frame smoothing;
performing an inter-frame smoothing of the internal motion of the segmented object in the sequence of frames to smoothly track the segmented object in the video; and
performing a downstream task on the tracked segmented object.

10. The method of claim 9, further comprising:
estimating an external motion in the sequence of frames caused by an operation of a camera filming the video; and
estimating the internal motion of the segmented object caused by the intra-frame smoothing based on a location of the segmented object in each frame of the sequence of frames.

11. The method of claim 10, wherein estimating the external motion comprises estimating the external motion based on metadata of the video.

12. The method of claim 10, wherein estimating the external motion comprises estimating the external motion based on a pixel correspondence of multiple pixels associated with the segmented object, wherein the multiple pixels include pixels outside of the segmented object.

13. The method of claim 10, wherein performing the intra-frame smoothing comprises enforcing a geometric constraint on the segmented object based on a linear regression of linear edges of the segmented object.

14. The method of claim 10, wherein the inter-frame smoothing is performed using a Kalman filter tracking the segmented object using a motion model and a measurement model, wherein the motion model includes the external motion and wherein the measurement model includes measurements of pixels of the segmented object modified with the intra-frame smoothing.

15. The method of claim 9, wherein the neural network is an incomplete convolutional neural network of low fidelity, such that the intra-frame smoothing compensates for distortions caused by operations of a camera filming the video and inaccuracies of segmentation caused by the low fidelity of the incomplete convolutional neural network.

16. The method of claim 9, wherein the background object is a banner having a rectangular shape, and wherein the downstream task includes replacing signage of the banner with an overlay comprising a different signage.

17. One or more computer-readable storage media having program instructions stored thereon that, when executed by one or more processors of a computing device, direct the computing device to at least:
collect a sequence of frames of a video of a scene;
process the sequence of frames with a neural network trained to segment and track a background object in the scene;
modify the segmented object in at least some of the frames by intra-frame smoothing, wherein intra-frame smoothing comprises enforcing a geometrical constraint on a shape of the segmented object;
estimate an internal motion of the segmented object in the sequence of frames caused by the intra-frame smoothing;
perform an inter-frame smoothing of the internal motion of the segmented object in the sequence of frames to smoothly track the segmented object in the video; and
perform a downstream task on the tracked segmented object.

18. The one or more computer-readable storage media of claim 17, wherein the program instructions further direct the computing device to:
estimate an external motion in the sequence of frames caused by an operation of a camera filming the video; and
estimate the internal motion of the segmented object caused by the intra-frame smoothing based on a location of the segmented object in each frame of the sequence of frames.

19. The one or more computer-readable storage media of claim 18, wherein to estimate the external motion, the program instructions direct the computing device to estimate the external motion based on metadata of the video.

20. The one or more computer-readable storage media of claim 18, wherein to estimate the external motion, the program instructions direct the computing device to estimate the external motion based on a pixel correspondence of multiple pixels associated with the segmented object, wherein the multiple pixels include pixels outside of the segmented object.
